(19) United States
(12) Patent Application Publication
(10) Pub. No.: US 2008/0252962 A1
(43) Pub. Date: Oct. 16, 2008

(54) Electronic Ink Display Device and Method for Manufacturing the Same

(75) Inventors: Yasuyuki Makubo, Hyogo (JP); Tadao Nakamura, Osaka (JP); Tomohiro Tsuji, Hyogo (JP); Yoshikazu Hirota, Hyogo (JP); Yuichiro Ohmae, Hyogo (JP)

Correspondence Address: BIRCH STEWART KOLASCH & BIRCH, PO BOX 747, FALLS CHURCH, VA, 22040-0747, US

(73) Assignee: TPO Hong Kong Holding Limited, Shatin (HK)

(21) Appl. No.: 11/791,763

(22) PCT Filed: Nov. 22, 2005
(86) PCT No.: PCT/IB05/53856

§ 371 Date: Mar. 10, 2008

(30) Foreign Application Priority Data
Nov. 30, 2004 (JP) 2004-347166

(51) Int. Cl. G02F 1/167

(52) U.S. Cl. 359/296; 359/513

(57) ABSTRACT

The invention provides an electronic ink display device having a panel structure of reduced thickness and enhanced moisture resistance and a method for manufacturing the same. The electronic ink display device has a first substrate (10) having display pixels, a second substrate (16) laid over the first substrate and having an electronic ink layer (13) on its lower major surface, the electronic ink layer having a space (26) terminating at a position with a predetermined distance receding from the periphery of the second substrate, and a seal (27) which fills the space and is laminated on the first substrate to cover at least part of the peripheral edge of the second substrate.

### TECHNICAL FIELD

The present invention relates to an electronic ink display device and a method for manufacturing the same, and more particularly, it relates to an electronic ink display device of a panel structure having reduced thickness and enhanced moisture resistance and to a method for manufacturing the same.

### BACKGROUND ART

Recently, a display device using an electronic ink has been researched and developed. The electronic ink is composed of micro capsules, as disclosed in Patent Document 1 listed below, that contain negatively charged black dye chips (particles) and positively charged white dye chips (particles). Applying an electric field to micro capsules causes the black and white dye chips to respectively move for display.

Such an electronic ink display device is typically manufactured by laminating a substrate comprising an electronic ink layer over a substrate containing display pixels.

In such an electronic ink display device, the reduced thickness is strongly desired.

Moreover, the electronic ink display device including an electronic ink layer is prone to be degraded since the electronic ink layer has insufficient moisture resistance, and as a result the electronic ink layer is deteriorated due to permeating external moisture.

For this solution, the applicant of this invention filed a previous application (i.e., Japanese Patent Application No. 2004-125669) in which the applicant proposed the improvement of enhanced moisture resistance that the display device is comprised of first and second substrate, and a protect substrate which is laid over the second substrate to have enhanced rigidity and which is dimensioned larger than the second substrate to induce the capillarity to fill a space between the overhanging reinforcing plate and the first substrate with a sufficient amount of sealing for enhanced moisture resistance.

For that purpose of the sealing, the sealant used therein includes photo-cured material, and preferably, ultraviolet (UV) cured material. After filling, the sealant is irradiated with ultraviolet rays and then photo-cured, thereby attaining sufficient moisture resistance.

[Prior Patent Document 1]

Japanese Patent Laid-open Publication No. 2002-202534

### DISCLOSURE OF INVENTION

### Technical Problem

In the aforementioned electronic ink display device, however, the reinforcing plate contributes to the enhancement of rigidity and moisture resistance but adversely increases in the total thickness of the whole electronic ink display device, and therefore, the result does not fully meet the requirements of users.

The present invention is made to overcome the aforementioned disadvantages in the prior art, and accordingly, it is an object of the present invention to provide an electronic ink display device of panel structure having reduced thickness and enhanced moisture resistance and a method for manufacturing such display device.

### Technical Solution

According to one aspect of the present invention, there is provided an electronic ink display device comprising:

a first substrate having display pixels,

a second substrate laid over the first substrate and having an electronic ink layer on its lower major surface, the electronic ink layer having a space terminating at a position with a predetermined distance receding from the periphery of the second substrate, and

a seal which fills the space and is laminated on the first substrate to cover at least part of the peripheral edge of the second substrate.

According to another aspect of the present invention, there is provided a method for manufacturing an electronic ink display device comprising the steps of:

laminating onto a first substrate containing display pixels a second substrate having at least an underlying electronic ink layer,

selectively removing the electronic ink layer to terminate it at a position with a given distance receding from the periphery of the second substrate, and

after the step of selectively removing the electronic ink layer, filling the resultant space with sealing material and laminating the sealing material on the first substrate to cover at least part of the peripheral edge of the second substrate.

### ADVANTAGEOUS EFFECTS

Thus, in accordance with the present invention, provided are a reliable thin film electronic ink display device having enhanced sealed state and moisture resistance without a reinforcing plate by virtue of sealant filling a space in a receding position from the periphery of the second substrate, and a method for manufacturing the same.

### BRIEF DESCRIPTION OF DRAWINGS

FIG. 1 is a schematic diagram showing a structure of an exemplary electronic ink display device according to one embodiment of the present invention;

FIG. 2 is a schematic diagram showing an exemplary FPL of the electronic ink display device in FIG. 1;

FIG. 3 is a diagram illustrating an exemplary manufacturing method of the electronic ink display device according to the present invention;

FIGS. 4(a) and 4(b) are diagrams illustrating a process step of bonding substrates in the manufacturing method according to the present invention;

FIG. 5 is a diagram depicting a process step of edge sealing in the manufacturing method according to an embodiment of the present invention;

FIG. 6 is a diagram illustrating a process step of sealant application in the manufacturing method according to the embodiment of the present invention.

### BEST MODE FOR CARRYING OUT THE INVENTION

Embodiments of the present invention will be detailed below in conjunction with the accompanying drawings.

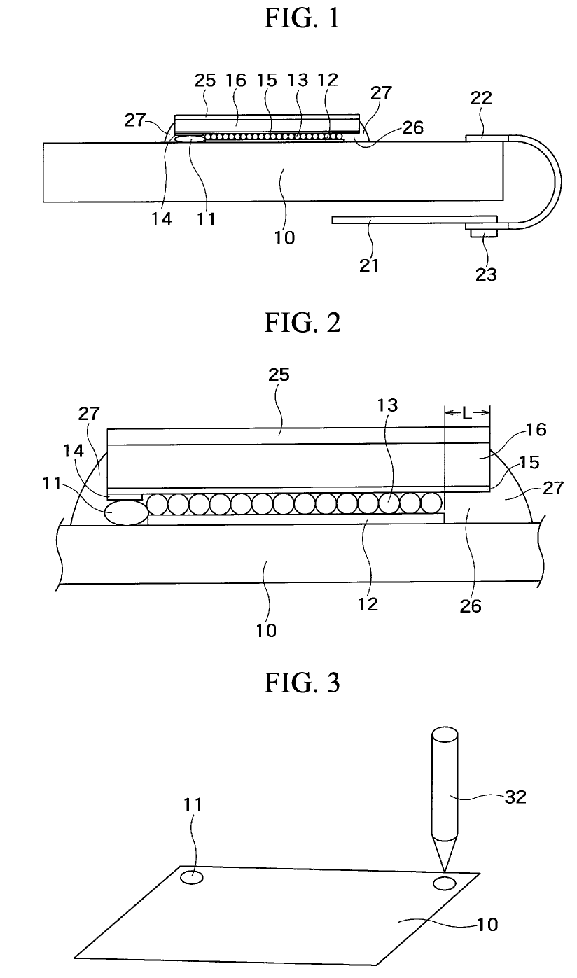

FIG. 1 is a schematic cross-sectional diagram illustrating a structure of an exemplary electronic ink display device according to the present invention.

In FIG. 1, primary components of the electronic ink display device according to the present invention are a thin film transistor (TFT) substrate 10 containing displaying pixels, and front plane laminates (FPL) 12-16 having an electronic ink layer and laid over the TFT substrate 10.

Specifically, an electronic ink layer 13 overlies the TFT substrate 10 with a lamination adhesive layer 12 intervening between them. The electronic ink layer 13 includes microcapsules encapsulating electronic ink therein, which are held in binder. A polyethylene terephthalate (PET) layer 16 having an ITO layer 15 are overlaid on the electronic ink layer 13.

The electronic ink layer 13 has its end provided with a top plane adhesive (TPA) layer 11. The TPA layer 11 is sandwiched between the TFT substrate 10 and a connection pad 14 which resides on the ITO layer 15 in the PET layer 16 in an area associated with the TPA layer 11. The connection pad may be an Ag pad, for example.

The thickness of the TFT substrate 10 is preferably about 200 to 700 μm. Preferably, the thickness of the TPA layer 11 is about 40 μm or thinner. Also, preferably, the thickness of the lamination adhesive layer 12 is about 20 μm or thinner. The thickness of the electronic ink layer 13 is preferably about 20 μm or thinner. The thickness of the connection pad 14 is determined depending upon the thickness of the TPA layer 11, preferably in a range of about less than or equal to 10 μm. It is also preferable that the thickness of the ITO layer 15 is about 1 μm or thinner and the PET layer 16 has a thickness ranging from about 100 to 250 μm.

The TFT substrate 10 is connected to one of the opposite ends of a tape carrier package (TCP) 22 while a printed circuit board (PCB) 21 is connected to the other end of the TCP 22. Also, on the other end of the TCP 22, a driver IC 23 for driving the display device is mounted. Although a combination of the TFT substrate 10 with the TCP 22 and PCB 21 connected to the same has been described in the context of this embodiment of the present invention, a tape automated bonding (TAB) substrate, a flexible printed circuit (FPC), and the like may take the place of the aforementioned substrates as those that are connected to the TFT substrate 10.

FIG. 2 is a schematic diagram showing a structure of the FPL of the electronic ink display device in FIG. 1.

As shown in FIG. 2, the FPL 12-16 are bonded on the TFT substrate 10.

In the FPL, the PET layer 16 has the ITO layer 15 overlying one of its major surfaces and has the electronic ink layer 13 over the ITO layer 15 and has the lamination adhesive layer 12 under the electronic ink layer 13. The PET layer 16 may additionally have a low-reflection layer 25 on the other of its major surfaces, as required, as shown in FIG. 2.

For the purpose of bonding the FPL 12-16 to the TFT substrate 10, as detailed later, first the TPA layer 11 is formed at a predetermined position on the TFT substrate 10, and then, the FPL 12-16 are bonded to the TFT substrate 10, being faced down so as to effect the lamination adhesive layer 12 in direct contact with the TFT substrate 10. During this procedure, the FPL 12-16 are to be positioned with the TFT substrate 10 the TFT substrate 10 to make the connection pad 14 of the FPL come in contact with the TPA layer 11. In view of this process step, the entire thickness of the lamination structure, allowing for the procedure of bonding the FPL 12-16 to the TFT substrate 10, is preferably about 300 μm or below.

As will be apparent from FIG. 2, the electronic ink layer 13 and the lamination adhesive layer 12 are terminated at a position with a distance L receding from the peripheral edge of the PET layer 16. The TPA layer 11 and its connection pad 14 have no recessions.

To form such recessions, the electronic ink layer should be dimensioned smaller prior to lamination, or otherwise, it may be removed by etching after lamination. The etching will be described later.

As a consequence, a space 26 is formed between the TFT substrate 10 and the ITO layer 15, and the space 26 is filled with an edge seal 27 while covering at least part of the peripheral edge of the PET layer 16 with the edge seal 27. The edge seal 27 prevents the electronic ink layer 13 from permeating of moisture, and thus, the electronic ink display device can have enhanced moisture resistance and reliability.

For that purpose, as the material of the edge seal 27, a photo-cured resin such as an ultraviolet ray curing resin is preferably selected. Any substance may be alternative to it if it retains sufficient moisture resistance and hardness after the photo-curing and if it has an appropriate fluidity during its application process.

In forming the edge seal 27, the interface between the TFT substrate 10 and the ITO layer 15 is coated with the photo-cured resin so that it can infiltrate through the capillarity to fill the space 26.

After filling, each side of the FPL 12-16 is irradiated with light beams (ultraviolet rays) orthogonal to it, which are directed toward the edge of the FPL and aimed at the photo-curing sealant filled between the TFT substrate 10 and the PET layer 16. Thus, the sealant is cured into the edge seal 27.

In this way, forming the space in advance results in the filling sealant increasing in amount, and this brings about a longer pathway to let moisture permeate, which can lead to a significant enhancement of moisture resistance.

Now described will be an exemplary method for manufacturing the electronic ink display device configured as mentioned above.

First, as can be seen in FIG. 3, the TPA layer 11 is formed at a predetermined position on the TFT substrate 10 having its surface cleansed. In this embodiment, a dispenser 32 is used to dispense the TPA layer 11 of which position is predetermined through positioning.

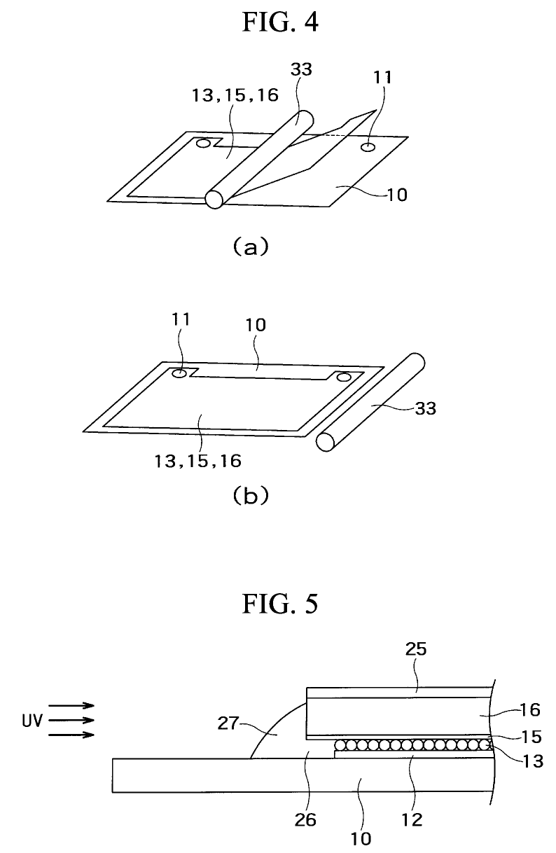

After that, as shown in FIGS. 4(a) and 4(b), the FPL is laminated onto the TFT substrate 10. In this step, after positioning the connection pad 14 over the TPA layer 11, the TFT substrate 10 together with the FPL is pressed by a roller 33 at a relatively high temperature (e.g., at about 100° C.).

As required, a low-reflection layer 25, which functions to block ultraviolet rays and assumes reduced glare, may be further superposed on the top layer of the FPL, namely, the PET layer 16.

Subsequently, as illustrated in FIG. 5, the electronic ink layer and the lamination adhesive layer 12 are recessed at a position with the distance L receding from the peripheral edge of the PET layer 16. As mentioned before, several methods can be taken to make such receding; that is, a way of superposing the electronic ink layer which has its periphery removed in advance, a way of letting the electronic ink layer undergo a selective chemical etching in some appropriate manner after the superposition of the same, or a way of removing the electronic ink layer through a mechanical etching after the superposition. During the etching after the lamination, the TPA layer 11 and its connection pad 14 must be masked to protect the area including those components.

The length of the recession should be preferably maintained at least 1 mm for the typical electronic ink display device in view of the moisture resistance.

Such a length of the recession should be determined depending upon a comprehensive judgment on how much margin the electronic ink layer is affordable for display area, an etching precision, a predictable extent of damage by the etching, and so forth.

Then, the space 26 formed in the recessions of the electronic ink layer 13 and the lamination adhesive layer 12 is filled with the sealant. The sealant may be a photo-cured resin (especially, ultraviolet setting resin is preferable).

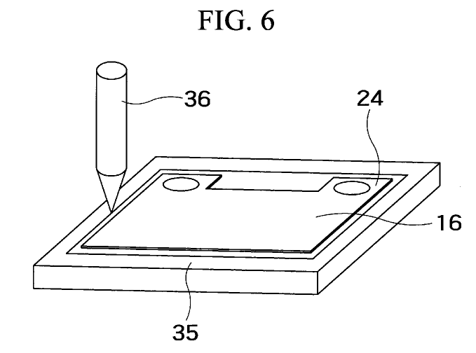

The coating with the sealant will be now described in conjunction with FIG. 6. During this procedure, while the TFT substrate 10 resides on a mount 35, a dispenser 36 is used to dispense the photo-cured resin onto the interface between the PET layer 16 and the TFT substrate 10. The capillarity facilitates to permeate the dispensed sealant 27 into the space 24 between the PET layer 16 and the TFT substrate 10 and eventually, completely fill the space. To assuredly fully fill the space 24, it should be preferable that most of the lateral edge of the PET layer 16 is coated with the sealant, or otherwise, at least part of it should be coated while the lower end of the sealant 27 on the TFT substrate 10 overhangs the lateral edge of the PET layer.

After coating with the sealant, the sealant is irradiated with light beams (ultraviolet rays) under predetermined conditions. Typically, four of light sources are simultaneously used to direct beams toward each side of the electronic ink display device in the direction orthogonal to it. This enables the sealant to completely cure and attain the enhanced sealing effect.

After the irradiation with light beams, the laminate structure may be heated as required to completely harden the photoset resin. As a consequence, the structure of more excellent moisture resistance can be implemented.

The present invention is not limited to the precise forms of the embodiments as disclosed herein above. For instance, to fill the edge sealant, some physical method may be used to force the sealant under pressure to flow and spread into the space 24 between the PET layer 16 and the TFT substrate 10, or alternatively, the edge sealant may be printed in advance in a predetermined area on the TFT substrate 10 so as to undergo a subsequent heat treatment for the desired fluidity and hardness.

Thus, the electronic ink display apparatus manufactured according to this embodiment has a panel structure of reduced thickness without a reinforcing plate and enhanced moisture resistance.

The present invention is not limited to the precise forms as disclosed in the aforementioned embodiments, but can be modified in various ways. For example, dimensions, numbers, materials of components used in the aforementioned embodiments are given by way of example, and should be interpreted as can be appropriately varied for the similar effects without departing from the scope set forth herein.

### LIST OF REFERENCE NUMERALS

10 TFT Substrate
11 TPA Layer
12 Lamination adhesive layer
13 Electronic Ink Layer
14 Connection pad
15 ITO Layer
16 PET Layer
21 PCB
22 TCP
23 Driver IC
25 Low-Reflection Layer
26 Space
27 Sealant
32, 36 Dispenser
33 Roller
35 Mount

1. An electronic ink display device comprising:
a first substrate having display pixels;
a second substrate laid over the first substrate and having an electronic ink layer on its lower major surface, the electronic ink layer having a space terminating at a position with a predetermined distance receding from the periphery of the second substrate; and
a seal which fills the space and is laminated on the first substrate to cover at least part of the peripheral edge of the second substrate.

2. A device as claimed in claim 1, wherein the second substrate comprises a laminated structure of at least a bonding layer, an electronic ink layer, an ITO layer and a PET layer.

3. A device as claimed in claim 1, wherein the second substrate further includes a low-reflection layer on its upper major surface.

4. A device as claimed in claim 1, wherein the sealing material is a photo-cured resin.

5. A method for manufacturing an electronic ink display device comprising the steps of:
laminating onto a first substrate containing display pixels a second substrate having at least an underlying electronic ink layer, selectively removing the electronic ink layer to terminate it at a position with a given distance receding from the periphery of the second substrate, and
after the step of selectively removing the electronic ink layer, filling the resultant space with sealing material and laminating the sealing material on the first substrate to cover at least part of the peripheral edge of the second substrate.

6. A method as claimed in claim 5, wherein the step of selectively removing the electronic ink layer is carried out through the mechanical or chemical etching.
